(19) United States
(12) Patent Application Publication
(10) Pub. No.: US 2026/0170700 A1
(43) Pub. Date: Jun. 18, 2026

(54) METHOD AND SYSTEM OF VIDEO CODING WITH NEURAL NETWORK-BASED REDUCTED BIT-DEPTH INPUT IMAGE DATA

(71) Applicant: Intel Corporation, Santa Clara, CA (US)

(72) Inventors: Li Xu, Shanghai (CN); Ming Lu, Beijing (CN); Yanjie Pan, Shanghai (CN); Yun Ye, Beijing (CN); Shan Gao, Beijing 11 (CN)

(21) Appl. No.: 19/122,887

(22) PCT Filed: Nov. 22, 2022
(86) PCT No.: PCT/CN2022/133479

§ 371 Date: Apr. 21, 2025

(51) Int. Cl. G06T 9/00; H04N 19/85

(52) U.S. Cl. CPC G06T 9/002; H04N 19/85

(57) ABSTRACT

Methods, articles, and systems herein use neural network-based reduced bit-depth image data input for video coding.

### BACKGROUND

As video coding and streaming of videos becomes more commonly used, the demand for high quality video keeps growing as well. Thus, techniques are used to reduce distortion, and in turn increase image quality while maintaining a target bitrate to maintain performance. It has been found that neural networks can be used for rate-distortion control to achieve the lowest possible distortion (e.g., highest quality images) at a given bit rate. Often, however, such neural networks are inadequate due to very large computational costs, inability to significantly reduce bitrate, and/or operations that undesirably increase distortion.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Furthermore, where considered appropriate, reference labels have been repeated among the figures to indicate corresponding or analogous elements. In the figures:

FIG. 1 is a schematic diagram of an example video coding system using neural networks according to at least one of the implementations herein;

FIG. 2 is a schematic diagram of an example neural network used in the video coding system of FIG. 1 according to at least one of the implementations herein;

FIG. 3 is a flow chart of an example method of video coding using input and output neural networks according to at least one of the implementations herein;

FIG. 4 is a flow chart of another example method of video coding using input and output neural networks according to at least one of the implementations herein;

FIG. 5 is a schematic diagram of an example training arrangement for training input and output neural networks of a video coding system according to at least one of the implementations herein;

FIG. 6 is a flow chart of an example method of training input and output neural networks of a video coding system according to at least one of the implementations herein;

FIG. 7 is a graph of rate distortion curves comparing the disclosed neural network-based video coding implementation to a conventional video coding system;

FIG. 8 is an output image generated by using conventional video coding;

FIG. 9 is an output image generated by using at least one of the video coding implementations herein;

FIG. 10 is an original image of a frame of a video sequence to be encoded by the disclosed video coding implementation

FIG. 11 is an encoder-input image generated by a neural network of an implementation of a video coding system disclosed herein;

FIG. 12 is a graph of rate distortion curves comparing the disclosed neural network-based video coding implementation to a conventional video coding system with reduced bit-depth encoder-input images;

FIG. 13 is another output image generated by using conventional video coding;

FIG. 14 is another output image generated by using at least one of the video coding implementations herein;

FIG. 15 is a schematic diagram of an example image processing system used with at least one of the implementations herein;

FIG. 16 is a schematic diagram of an example system; and

FIG. 17 is a schematic diagram of another example system, all arranged in accordance with at least some of the implementations of the present disclosure.

### DETAILED DESCRIPTION

One or more implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes unless stated otherwise. For instance, various architectures employing, for example, multiple integrated circuit (IC) chips and/or packages, and/or various computing devices and/or consumer electronic (CE) devices such as set top boxes, smart phones, tablets, mobile devices, computers, etc., may implement the techniques and/or arrangements described herein. Furthermore, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Furthermore, when a particular feature, structure, or characteristic is described in connection with an implementation, it is submitted that it is within the knowledge of one skilled in the art to affect such feature, structure, or characteristic in connection with other implementations whether or not explicitly described herein.

Systems, articles, media, devices, and methods are described below that relate to video coding with neural network-based reduced bit-depth input image data according to the implementations herein.

Neural networks are now used in video coding pipelines for a number of tasks. Some neural networks are used for conventional pre-processing to denoise frames, while other neural networks are used for conventional post-processing to remove artifacts. Yet other neural networks are used to replace the conventional coders (the encoders and decoders) themselves to attempt to provide better distortion rates by lowering bitrates to increase performance while increasing, or at least maintaining, the quality of the images. The coder replacement neural networks, however, have been found to be inadequate due to incompatibility issues, large computational loads, and so forth that make these replacement neural networks impractical.

Other attempts at using distortion-reducing neural networks include using a dual set of input and output neural networks to be used with conventional coders. This may include a pre-processing neural network to provide modified frames to an encoder and a post-processing neural network that reverses the changes from the pre-processing neural network. The post-processing neural network receives decompressed output from a decoder and then converts that decoder output back to reconstructed images but now with less distortion. These neural networks learn lower bit image representations that can be compressed with the conventional coders that uses a standard codec, except now with a much lower bit rate. Challenges still arise, however, from weak connections between deep neural network (DNN)-based pre- and post-processing, as well as a non-differentiable property of standard codecs. In other words, the connections are weak because most existing DNN-based pre-processing and DNN-based post-processing focus on different tasks, and standard codecs use quantization which is non-differentiable, and therefore, the conventional dual neural network systems with standard coders cannot be used directly for gradient descent type of algorithms.

Thus, for conventional video coding systems with both the pre-processing and post-processing neural networks, the network training uses very complex image codec proxies rather than standard coders with known codecs in order to simulate gradient descent back propagation. Also, these conventional systems still provide image channels to be input to an encoder with full bit-depths, such as 8, 10, 16, or more bits per pixel resulting in bitrates per frame that are still unnecessarily high while attempting to provide relatively low distortion (or high image quality), thereby increasing bandwidth requirements.

Other example systems with two neural networks merely use a pre- and post-processing network that downscales and then performs video super-resolution or upscaling operations to recover texture details. Not only are these systems not true dual neural network systems that learn different image domains that can be compressed and decompressed as mentioned above, these systems are often inadequate because these systems cannot regain enough detail lost in the down-scaled inputs.

To resolve these issues, a method and system disclosed herein uses an input pre-processing neural network (PRPNN) at an encoder side that converts an input frame into one or more image channels that are a representation of the image with less bits. A standard encoder and decoder, instead of an image codec proxy for example, compresses and decompresses the encoder-input image data. An output post-processing neural network (POPNN) then can use the decompressed image (output-decoder image data) to recover or reconstruct an output image closer to the initial input frame with less distortion compared to conventional techniques. This is accomplished with very high performance by having the PRPNN reduce a bit-depth of at least one of the channels of the input frame, such as less than 8 bits per pixel by one example. Also, the input image may be formed of three color space channels, such as RGB. When the bit-depth reduction is performed in addition to inputting less than all three of the channels into the PRPNN, this further significantly reduces the amount of bits per frame to be processed by the encoder since either the values of the image data will be reduced (when coding must be in YUV) or the encoder can avoid coding all three RGB channels (the missing channels can be filled with all zeros) when the coding occurs in RGB, thereby reducing bitrate while still maintaining image quality. Using reduced bit-depths alone, or in addition to using less than all channels, substantially reduces the bits per channel in a way that enables a better ability for recovery with a low distortion. As explained below, this results in a significant increase in structural similarity index measure (SSIM) used to represent image quality as a scale from 0 to 1. It should be noted that the terms image, picture, and frame are used interchangeably herein and may each be formed of multiple channels or surfaces related to a color space for example, such as RGB, YUV, and/or BGR, to name a few examples. These color spaces may have additional fourth or more channels, such as an alpha channel for transparency data, such as with ARGB or AYUV that is ignored by the PRPNN. Otherwise, any color space may be used that can be formed of channels.

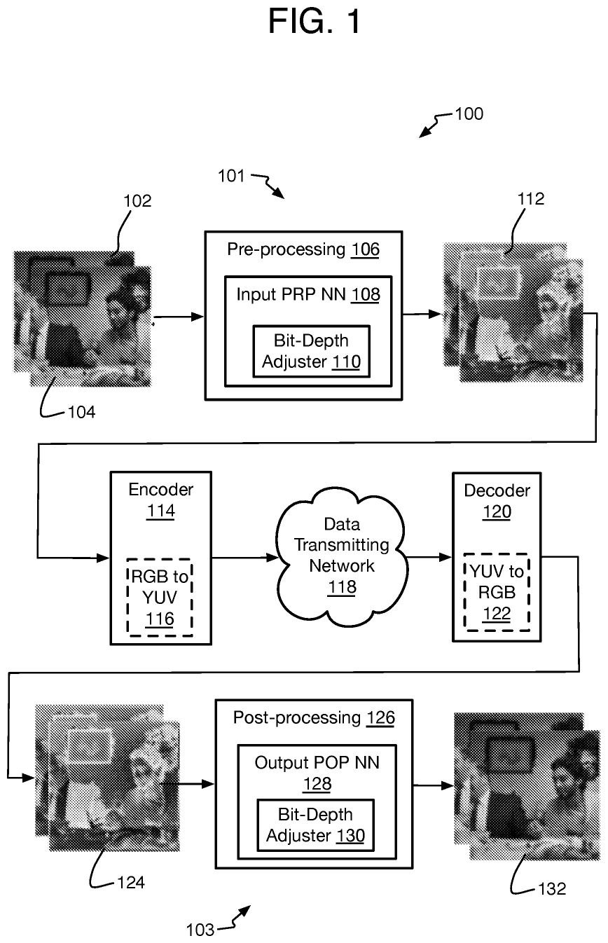

Referring to FIG. 1, an image processing system or device (or video coder or video coding pipeline) 100 has an input or encoder side 101 to compressed images to transmit to an output decoder side 103 of the image processing system 100. The encoder side 101 has a pre-processing unit 106 and an encoder 114. The pre-processing unit 106 may have an input PRPNN 108 that has a bit-depth adjuster unit 110. A data transmitting network 118, such as the internet or other network, transmits compressed data from the encoder 114 to a decoder side 103 that has a decoder 120 and a post-processing unit 126. The post-processing unit 126 may have an output POPNN 128 with its own bit-depth adjuster unit 130.

The encoder side 101 receives input images or frames 102 of a video sequence where each image 102 is formed of multiple color space (and/or other type) channels or surfaces each with an array of initial pixel image data 104. The input images 102 are input into input channels of the input PRPNN 108 which generates encoder-input image data or images 112 to be input to encoder 114. The bit-depth adjuster 110 may reduce the bit-depth of a version of the input image data such as one or more channels, and may be less than all channels.

Since the input-encoder images 112 may be formed with at least one channel of reduced bit-depth, and may or may not include less than all color space channels, the input-encoder images 112 may not be recognizable to a person. For instance, one or more channels of the input-encoder images 112 may appear to be blurry or have missing detail due to the reduction of bit-depth. Also, the input-encoder images may appear to be in a different color domain, whether a tint in a certain color such as green or yellow, or even a grey scale image, depending on which one or two color space channels are being maintained. The encoder 114, being a non-modified or standard encoder, will receive these network domain input-encoder images and treat them like any other normal run-time images to be compressed.

Continuing with the description, the encoder 114 may have those components, units, logic, and/or circuitry to perform compression of video frames or images and are well known for operating the encoder during a run-time stage such that they do not need a detailed description here. The encoder 114 also will have codec, abstraction layers, parameters, parameter sets, non-video coding layers, supplemental enhancement information, and other accompanying data collectively referred to herein as encoder instructions or encoder settings. The encoder codec is not limited to any particular video codec and may be H.264, H.265, High Efficiency Video Coding (HEVC), Advanced Video Coding (AVC), VP #, and/or any other video coding standard.

Also, the encoder 114 may or may not have a color space conversion unit, such as RGB to YUV unit 116, when the encoder only encodes data in YUV color space, and converted from RGB or other color space. By one alternative, such a conversion unit may be provided as a unit separate from and upstream from the encoder, whether before or after the pre-processing unit 106.

The data transmitting network 118 may be any computer or communication network that is able to transmit compressed image data, whether the internet or other packet transmitting network, a wide area network (WAN), local area network (LAN), and so forth. Such a network may be hard wired, wireless, or some combination of both.

As with the encoder 114, the decoder 120 also may have those decoder components and settings as are well known to operate the decoder during a run-time. The decoder side 103 may provide the decoder 120 with a color space inverter, such as a YUV to RGB inverter 122 if desired. As with the converter, the inverter 122 may be separate or part of the decoder 120, and may be before or after the post-processing unit 126 as desired, and when needed by the decoder 120. The decoder outputs output-decoder image data (or frames or images) 124 still with at least one channel with a reduced bit-depth.

The output-decoder image data 124 is provided to the post-processing unit 126 and input into the POPNN 128 to generate low distortion output images 132 that are similar or the same as input images 102, and with much lower distortion than coding without the neural networks, and better performance than without the bit-depth reduction. The bit-depth adjuster 130 of the post-processing unit 126, as with the bit-depth adjuster 110, may be considered part of the POPNN 128 or separate from the network. The bit-depth adjuster 130 is arranged to increase the bit-depth of the bit-depth-reduced channels of the output-decoder images 124, usually back to the original bit-depth of the input images 102, but need not always be so. Despite being compressed and then decompressed in a network domain, the output-decoder images 124 output from the coders and input to the post-processing unit 126 described herein still generates output images 132 close to the input images 104 with less distortion and lower bitrate than without the use of the neural networks 108 and 128.

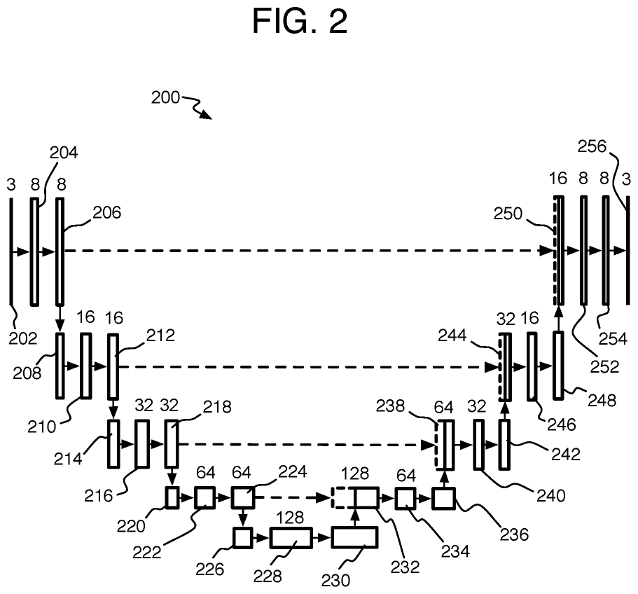

Referring to FIG. 2, an example PRPNN 200 is provided that is the same or similar to PRPNN 108, and that has the same or similar architecture as POPNN 128 as well. By one example form, the PRPNN 200 has a U-net architecture although many different architectures could be used instead as long as the neural networks are trained for distortion reduction by improved compression representation and provides for bit-depth reduction of at least one channel after at least one of the network layers, which could be the last layer.

In more detail, the example PRPNN 200 has an input layer 202 with three (or other number) input channels, one channel for each color channel of the color space of the input image, such as RGB. It should be noted that the layer and channels of a layer may be referred to herein interchangeably. By one form, less than all three channels may be used in order to reduce the total number of bits per pixel, and in turn the computational load and bitrate for the image or frame. Thus, one, two or three channel surfaces may be input for an RGB image. Thus, for RGB video (or other three-channel color space images), the representation to be output from the pre-processor 106 can be an image using either RG, RB, or GB channels, or one of the R, G, or B channels. This can be performed by entering zeros into the input channel or layer of the PRPNN 200 for an array of the pixel data or image data locations of the input channel corresponding to the channel being dropped. By one form, all three channels are treated the same in the example network 200 so that it does not matter which input channel receives the zeros for a channel of the image to be dropped. For example, for the case of maintaining RG channels, the B channel will be dropped and the pixel values for one of the input channels on layer 202 should have all zeros and it does not matter which input channel that is. By an alternative form, when one or two (or other number) channels are to be dropped, this is fixed as to which input channel 202 will be filled with zeros. In either case, the PRPNN 200 can be trained to output an input-encoder image channel to have all zeros to represent the dropped input channel.

By yet another approach, the PRPNN 200 is trained to receive only the non-dropped channels. Thus, for RGB for example, the input layer 202 of the PRPNN 200 may only have 1 or 2 input channels when respectively 2 or 1 channels of the input image are to be dropped. In this case, output channels of the output layer 256 on the PRPNN 200 only outputs 1 or 2 non-zero channels. In this case, a third (or second and third or more) zero channel then may be added as input for the encoder when the encoder is expecting three or more channels.

As far as the size or resolution of the layers, the input channels can be any desired resolution. By one example form, tested herein as described below, a 2560×1600 pixel (or Wide Quad Extended Graphics Array (WQXGA)) was used. By one form, no limit exists as to which display sizes or resolutions can be used other than the performance limitations of the system. The size of the remaining layers on the example PRPNN 200 then depend on the previous layer operations such as by convolution filters, pooling filters, and so forth as described below.

Thus, for the present example, once the input image data are received at the input channels 202, the layers of the example PRPNN operate as follows. A 3×3 convolution and subsequent rectified linear unit (ReLU) are performed by layers 202, 204, 208, 210, 214, 216, 220, 222, 226, 228 of a downsampling side of the U-shaped network 200 and layers 232, 234, 238, 240, 244, 246, 250, and 252 on an upsampling side of the network 200. A downsampling 2×2 max pooling operation is performed by layers 206, 212, 218, and 224 on the downsampling side, while an upscaling 2×2 convolution is performed by layers 230, 236, 242, and 248 on the upsampling side. Feature maps are copied from layers 206, 212, 218 and 224 and respectively concatenated onto layers 250, 244, 238, and 232 as shown by the dashed arrows across the U-shape of the network 200. The second-to-last layer 254 performs a 1×1 convolution to provide three channels of the output layer 256 thereby forming the input-encoder image data to be input into an encoder 114. The number of channels input and existing at each layer is shown on PRPNN 200 above the corresponding layer. For each downsampled layer 208, 214, 220, and 226 the number of channels is the same as the number of channels of the downsampling layer, and for each upsampling layer 230, 236, 242, and 248, the number of channels is the same as the number of channels of the previous layer.

For the post-processing POPNN 128, the architecture may be the same because, although similar, the output-decoder image data or images 124 are still a degraded representation relative to the input-encoder image data or images 112 due to the video compression. Thus, the POPNN 128 may be trained to restore images by removing the degradation introduced by the compression similarly to how the pre-processing unit 106 is removing distortion while generating the input-encoder image data. By other forms, the POPNN may be different than the PRPNN such as having a three channel input when the PRPNN may have only an one or two channel input.

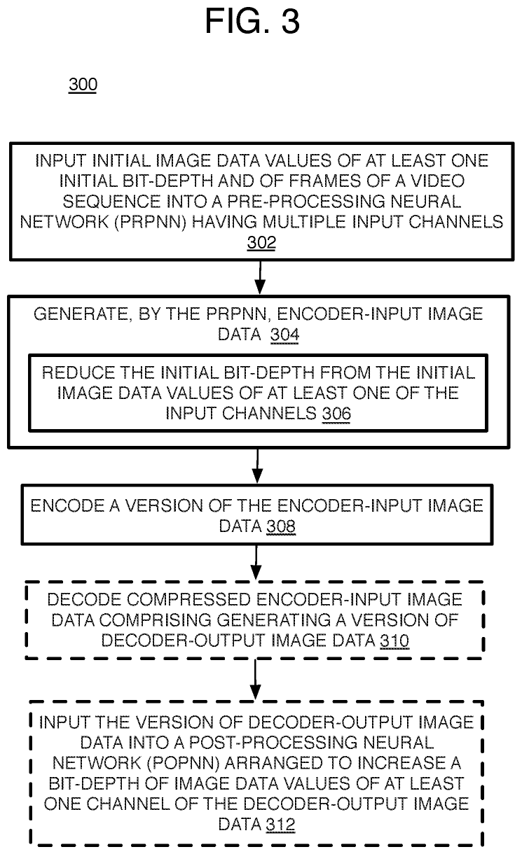

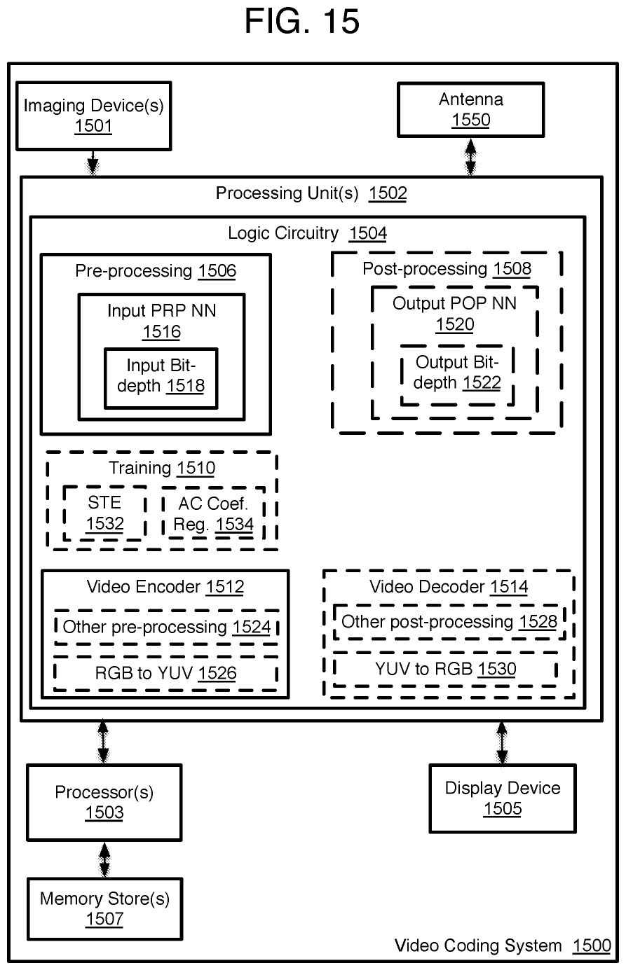

Referring to FIG. 3, an example process 300 of video coding with neural networks is arranged in accordance with at least some implementations of the present disclosure and is mainly directed to the encoder side. In the illustrated implementation, process 300 may include one or more operations, functions or actions as illustrated by one or more of operations 302 to 312 numbered evenly. By way of non-limiting example, process 300 may be described herein with reference to example systems 100 or 1500 of FIG. 1 or 15 respectively, or neural network 200 of FIG. 2, and as discussed herein.

Preliminarily, process 300 may include obtaining or receiving image data of frames of a video sequence (such as images 102 (FIG. 1)), and this may include obtaining non-compressed image data either from a decoder for re-encoding the image data such as at a transcoder, or could be raw image data obtained from a camera. Whether raw or with some format processing, the image data may be obtained from a memory.

As other preliminary operations, conventional pre-processing may be performed at least sufficiently for encoding such as demosaicing raw image data, denoising, image pixel linearization, shading compensation, resolution reduction, vignette elimination, image sharpening, and so forth. When appropriate, any one or more of such conventional pre-processing tasks may occur before or after the neural network pre-processing described herein or may be a task performed by the encoder itself. This also may include the color space conversion as described above.

Process 300 may include “input initial image data values of at least one initial bit-depth and of frames of a video sequence into a pre-processing neural network (PRPNN) having multiple input channels” 302. This involves inputting the input images, in the form of the color space channels, into a first layer of PRPNN, such as PRPNN 200 or 108 as described above. As mentioned, when less than all channels are being used, such as one or two channels rather than all three channels, such as for RGB format for example, the unused channels may be filled with zeros. This creates a same adaptable PRPNN that can be used for a variety of channel combinations, such as RG, GB, or BR, or R, B, or G to be used alone.

By one form, which input channels receives the zeros is fixed such that the system is fixed to drop one or two color channels, and may be fixed as to which color channels are to be dropped when a image data of a same predetermined color space is always being received, such as RGB. By other options, the neural network may provide an option of dropping one or two color channels, or dropping one or two or no channels, and the input channel of PRPNN may be filled with zeros in a certain input channel order depending on which option is being used. This may be an automatic decision depending on a target bitrate history meeting thresholds for a current video sequence being coded and transmitted, for example. By an alternative form, which one or two input channels to be dropped on the PRPNN is not fixed.

Process 300 may include “generate, by the PRPNN, encoder-input image data” 304, where the input image data is then propagated through the layers of the PRPNN as described above. As mentioned, a U-net structure is only one example architecture that could be used.

This generating operation 304 may include “reduce the initial bit-depth from the initial image data values of at least one of the input channels” 306. The bit-depth reduction can be accomplished in a number of different ways. For example, the bit-depth may be indirectly manipulated by restricting the output value range in my training. For example, if an R-channel was to be reduced from 8 to 4 bits, a floating point output from a neural network layer could be clamped to be an integer value in a closed interval range of [0, 16] (which is a maximum 4 bits in binary). This has the effect of dropping most significant bits (MSBs).

By other alternatives, the locations in an image value to drop to reduce the bit-depth, as long as the same for all image values in a channel or surface, may be predetermined but are not limited to any specific bit locations within the initial image data value solely due to the encoder. The encoder will compress the images no matter which bit locations have been dropped. For example, a predetermined number of least significant bits (LSBs) may be dropped from the end of image values of a channel to reduce the bit-depth. By yet another option, values from a middle of the image data value may be dropped, such as (10101010→101xx010). By yet other options, while these pixel locations are consecutive, non-consecutive locations could be selected as well, such as every other bit location, and other such pattern. It does not make a difference at the encoder itself, purely for compression tasks, as to which bit locations are dropped since the encoder itself does not directly factor the recognition or quality of the input image content to be encoded.

By one form, 10, 12, 16, or greater bit-depths of the input images may be reduced to 8 or fewer bits or less than 8 bits. By one form, the bit-depths are reduced to 4 to 6 bits. By one form, one input channel may be reduced to 6 bits, another input channel may be reduced to 4 bits, and the third channel is not changed. By one example, two channels of three have the same reduced bit-depth, such as 4 or 6 bits. By other alternatives, all three input channels have reduced bit-depths, and the reduced bit-depths may be the same or different for the input channels in any combination. For example, a 10 bit bit-depth for all input channels may be reduced to 8, 6, and 4 bits associated with three channels. By one form, one or two channels may have a bit-depth reduced from 8, 10, 12, or 16 bits to 4 to 6 bits, or less than 6 bits, or less than 4 bits.

Also as mentioned, the bit-depth reduction may be performed after the last layer of the PRPNN provides output (or may be an operation considered to be part of the output layer). Alternatively, however, the bit-depth reduction itself could be performed after any selected layer of the PRPNN, or may be performed before the input images are input into the first layer of the PRPNN. Regardless of the timing of the bit-depth reduction and which of the three (or other number) channels were input, the last layer output then may be rounded to an unsigned int8 value or other value as desired to form the input-encoder image data or frames to be provided to the encoder.

It also should be noted that even though the PRPNN layer types in this example will combine values across channels to reorganize convolved, pooled, and/or concatenated data into a different number of channels, in this example, the PRPNN can be trained, as explained below, to output a channel of zero values for each input channel that was dropped. By other alternatives, the propagation of input images from the input channels could be kept separate from each other through the PRPNN to output the same number of non-zero channels that are input. By yet another option, non-zero image data of three channels may be output from the PRPNN to form the input-encoder image data regardless of how many channels were dropped at the input into the PRPNN.

Process 300 may include “encode a version of encoder-input image data” 308, where an encoder then compresses the input-encoder image data received from the PRPNN. As mentioned, by one form, the encoder may be a conventional or standard encoder, such as encoder 114 described above. In other words, by one form, the encoder is used without modifications being made solely for the neural networks in order to operate during a run-time that is beyond the type of parameter or other encoder settings changes that could normally be made for a run-time of the encoder. The encoder receives the three (or other number) of channels of a color space (one or two of which may have image data with all zeros), then may perform other pre-processing when needed as described above. The encoder, if not performed already, also may convert the color space as needed to an encoder-expected color space such as from RGB to YUV, and then performs the compression. The encoder typically processes a sequence of a single channel (or surface) separately from the other channels. Thus, the encoder will output three (or other number) compressed channels such as in YUV color space. It should be noted that the encoder should preserve the zero values within the YUV image data so that the dropped RGB channels with zero values can be reconstructed after decoding of the YUV image data and to be subsequently input into the POPNN.

Thereafter on a decoder side, process 300 may include “decode compressed encoder-input image data comprising generating a version of decoder-output image data” 310, and “input the version of decoder-output image data into a post-processing neural network (POPNN) arranged to increase a bit-depth of image data values of at least one channel of the decoder-output image data” 312. These decoder side operations as well as other operations are described in detail below with process 400.

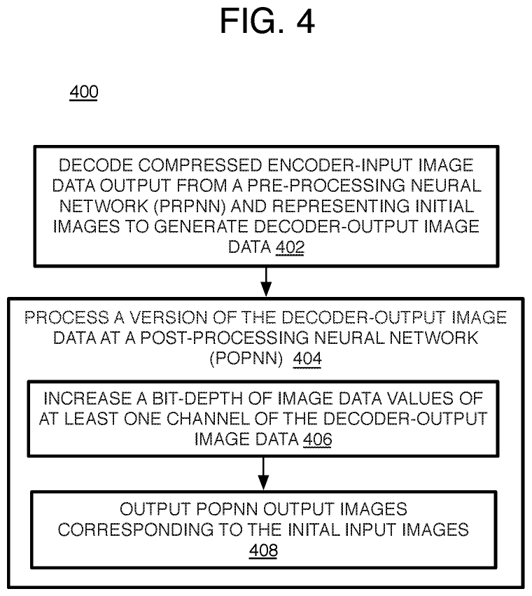

Referring to FIG. 4, an example process 400 of video coding with neural networks on the decoder side is arranged in accordance with at least some implementations of the present disclosure. In the illustrated implementation, process 400 may include one or more operations, functions or actions as illustrated by one or more of operations 402 to 408 numbered evenly. By way of non-limiting example, process 400 may be described herein with reference to example systems 100 or 1500 of FIG. 1 or 15 respectively, and/or neural network 200 of FIG. 2, and as discussed herein.

Process 400 may include “decode compressed encoder-input image data output from a pre-processing neural network (PRPNN) and representing initial images to generate decoder-output image data” 402, where the decoder also may be a conventional decoder and may be unmodified for run-time use and may be used with the PRPNN and POPNN. More specifically, encoder-input image data represented by color space channels may output from the PRPNN and provided to an encoder for compression. The decoder then may receive the compressed image data transmitted over a computer or other network as described above with network 118 (FIG. 1). The compressed image data may be in one color space expected by the decoder, such as YUV or RGB. The decoder performs the decompression and generates the number of channels of the decompression color space, such as YUV or RGB. The color space then may be converted to a desired color space at least to be used at the POPNN, but also may be the color space expected at subsequent applications such as renderers. Thus, the decoder may have or communicate with a color space inverter that converts the YUV back to RGB. Again, when the PRPNN is trained to provide dropped channels with zeros as the image data values, the coders may carry the zero values through by reducing the YUV values or by having zero-value channels when RGB is maintained at the coders. The process is reversed after decoding so that R, G, and/or B zero channel is maintained when the coders process in RGB, or the R, G, and/or B zero channel is reconstructed during the inversion operation from YUV to RGB. This results in an expected three channels (for RGB) being provided to the POPNN even though one or more of the channels may be zero channels.

Process 400 may include “process a version of the decoder-output image data at a post-processing neural network (POPNN)” 404. Also as mentioned, the POPNN may have a similar or same U-net or other structure that is trained with the PRPNN to reduce distortion on output-decoder images. The version of the decoder-output image data may be the RGB version inverted from a YUV version output from the decoder. As described below, other post-processing may have been applied as well.

Thus, an expected version of the output-decoder image data (or image or frame) represented by color space channels, whether or not including a zero channel, may be input into input channels of a first layer of the POPNN, and similar to the first layer of the PRPNN. Process operation 404 then may include “increase a bit-depth of image data values of at least one channel of the decoder-output image data” 406. As with the PRPNN, the increase of the bit-depth back to its original bit-depth on the input images or other desired increased bit-depth may be performed at a number of different stages whether before or after any of the layers in the POPNN including the first or input channels on a first layer or the last or output channels on a last layer of the POPNN. By one example, the bit-depth increase is performed before the first layer of the POPNN.

By one approach, the bit-depth increase may be performed by increasing a floating point range of output at one of the layers on the POPNN, followed by rounding, such as [0,255] to increase a 4 or 6 bit channel back to 8 bits. Otherwise, other decoder-side bit-depth increasing alternatives include rescaling the output-decoded image by multiplying each or individual pixel image values by a ratio of the maximum integral value of the ranges of the two bit-depths in the inversion, such as 255/63 such that the output bit-depth range will be [0, 255]. This may be performed before feeding the output-decoder image data into the POPNN and the regularization term. Other alternatives include, feeding into POPNN without regularization if other rate limit methods are available. Also, the range values for both reducing and increasing bit-depth could be performed with normalization to image data value ranges of [0,1] when desired to simplify computations. The output can then be multiplied by the maximum image data range value, such as 63 or 255.

The processing 404 also may include “output POPNN output images corresponding to the initial input images” 408. Thus, three non-zero channels may be output from the POPNN, and regardless of the number of zero channels input to the POPNN. This operation also may include performing any desired post-processing, such as artifact removal, resolution scaling, and so forth. While in this example the post-processing may occur downstream of the POPNN, alternatively such post-processing could be considered a part of the decoder and could be applied to output from the decoder before being input to the POPNN, and either before or after a post-decoding color space conversion if used and described above. The final output images then may be placed in storage, provided to another encoder or coding system for re-transmission, or provided to an end application such as a renderer.

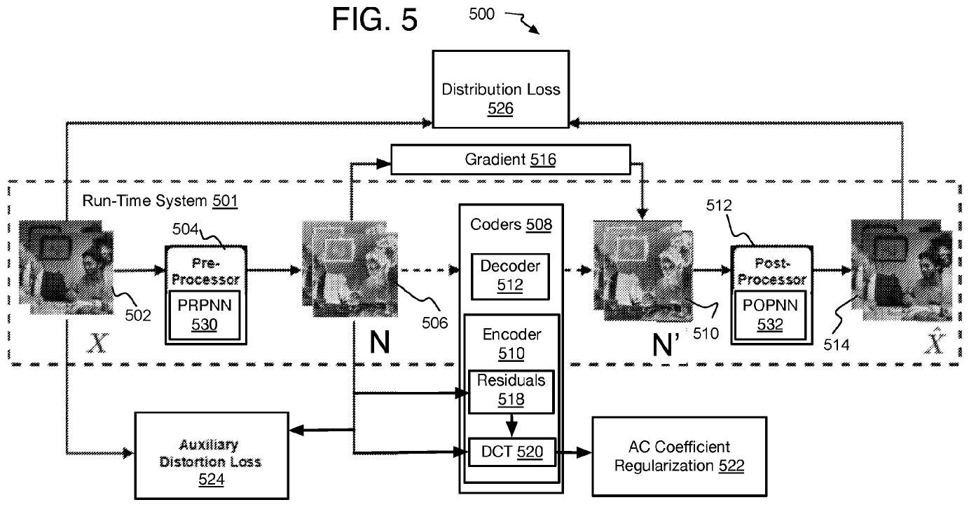

Referring to FIG. 5, a training arrangement or setup 500 is provided to train the PRPNN and POPNN while using a real encoder and decoder that has structure and settings (encoding state) that is the same as if the coders are being used during a run-time for image coding rather than using a differentiable image codec proxy just for training. While this architecture can be trained with an image codec proxy, the presently disclosed training arrangement avoids the complexities of the image codec proxy that requires a very large amount of programming work to implement and decreases accuracy due to the proxy's insufficient approximation or a standard or real codec.

The training arrangement 500 may have a run-time system 501 that is the same system that may be used during run-time and may be the same or similar to system 100 described above. Here, however, the input images 502 (or channels) labeled as X are provided to a pre-processor 504 with a PRPNN 530, such as PRPNN 108 or 200, and the input-encoder image data or image channels (or neural network (NN) images) 506 output from the pre-processor unit 504 are labeled as N and to be input to coders 508. The coders 508 may include an encoder 510 and decoder 512. Decoded images or channels labeled as N′ are the output-decoder images (or channels) provided to a post-processor 512 with a POPNN 532, such as POPNN 128. The output channels (or images) 514 from the post-processing unit 512 are labeled as X.

The training units added to perform the training tasks include a gradient unit 516 that may perform straight through estimation or other gradient algorithms as described below, bitrate regulation or regulators, such as an AC coefficient regulation unit 522. The encoder 510 uses a residuals unit 518 used to generate DCT coefficients at a DCT unit 520. The AC regulation unit 522 uses the DCT coefficients to determine estimated bitrates to factor in the gradients. The training units also may include another bitrate regulator such as an auxiliary distortion loss unit 524 to adjust the gradients, and a distortion loss unit 526 that determines total distortion to be minimized during the training. It should be noted that other regulators could be used instead or in addition to one or both of the regulators mentioned. By one form, the auxiliary distortion unit 524 is used when the bit-depth is being scaled. Thus, the AC coefficient regulation could be used alone when no scaling is being performed. The auxiliary distortion loss unit 524 also may be used along when found to be sufficient. The training arrangement is operated as explained in process 600 below.

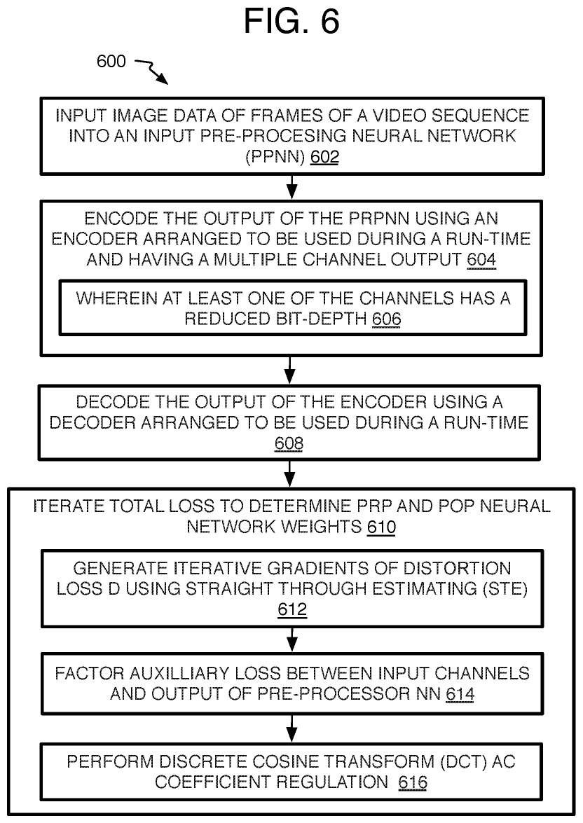

Referring to FIG. 6, an example process 600 for training pre-processing PRPNN 530 and post-processing POPNN 532 for video coding is arranged in accordance with at least some implementations of the present disclosure. In the illustrated implementation, process 600 may include one or more operations, functions or actions as illustrated by one or more of operations 602 to 616 numbered evenly. By way of non-limiting example, and in addition to training arrangement 500, process 600 may be described herein with reference to example systems 100 or 1500 of FIG. 1 or 15 respectively, and/or neural network 200 of FIG. 2, and as discussed herein.

Process 600 may include “input image data of frames of a video sequence into an input pre-processing neural network (PRPNN)” 602. The datasets used for the training were selected to provide typical video clip samples of a target application. For example, cartoon clip samples for cartoon video services. By one form, the training may be performed using a Vimeo-90K dataset, although many others also may be adequate. Otherwise, the operations for inputting the color space channels, whether all channels or less than all channels (zero channels), into the input layer are as described above.

Process 600 may include “encode the output of the PRPNN using an encoder arranged to be used during a run-time and having a multiple channel output” 604. This refers to using an encoder with architecture, parameters, and codec that is not modified specifically for the training other than adjusting typically modifiable parameters and encoder settings. This may be referred to as a “standard” encoder or encoding herein, and instead of using image codec proxies which typically do not sufficiently reproduce the compression result of a standard codec in order to provide differentiable values, as mentioned above.

The encoding operation may include “wherein at least one of the channels has a reduced bit-depth” 606, and as described above one of the input color space channels may have its bit-depth reduced at the output of the PRPNN to form input-encoder image data to be input into the encoder. By one form, for a three channel color space, such as RGB, at least one, but two or three of the channels may have its bit-depth reduced. By one form, one or two channels may have a bit-depth reduced from 8, 10, 12, or 16 bits to 4 to 6 bits, or less than 6 bits, or less than 4 bits as mentioned above. One or more of the channels fed to the encoder also may have zero value image data to represent dropped channels as described above as well.

Process 600 may include “decode the output of the encoder using a decoder arranged to be used during a run-time” 608, as described above. By one form, the encoder and decoder may be considered usable for run-time no matter the adjustments or type of coders used as long it is not an image coding proxy or other type of proxy that does not provide a sufficiently same or exact reproducibility of standard codecs, as explained above.

Process 600 also may include “iterate total loss to determine PRP and POP neural network weights” 610. In DNN-based video compression, one example loss function to be minimized by gradient descent is formed as:

$$L = D + λ R \qquad ( 1 )$$

where D is the distortion loss between a reconstructed frame \hat{X} and the original frame X, λ is a loss weight, and R is the rate loss for a lower bitrate of the representations (N) compared to a bitrate of uncompressed input image without pre-processing. The distortion loss D may be stated to include the distortion loss D(X, \hat{X}) between the initial input images X 502 input to the PRPNN 530 and the output image 514 output from the POPNN 532.

The rate loss R here may have two parts in order to better regulate R so that image accuracy or quality can be maintained while providing good performance. Thus, R may include factoring an auxiliary distortion D(X_{(channels)}, N) to modify the total loss. This forces the channel representation N 506 to be more similar to corresponding channels of X 502 because distortion between X_{(channel)} and N is minimized during training. This in turn will force the bitrate of the compressed images or channels N′ 510 to be closer to the bitrate of the compressed frame without any preprocessing. Otherwise, another part of rate loss R is an AC coefficient regulation part to estimate bitrates as described in detail below.

As to the details of the distortion loss factor D(X, \hat{X}), the distortion loss gradients for back propagation during gradient descent cannot be obtained directly from the coders as mentioned above because (1) standard codecs typically are not implemented with tools and languages that support auto numerical differentiation, and (2) quantization (or rounding) operations in video compression are naturally non-differentiable.

Thus, it has been found that the back propagation can be simulated instead while still using standard coders and without the use of a complex image codec proxy. Such back propagation simulation techniques may include soft quantization, adaptive noise, or straight through estimation (STE). It has been found that STE performs well, and better than the other two techniques during experimentation.

Thus, the iterating 610 may include “generate iterative gradients of distortion loss D using straight through estimating (STE)” 612. Specifically, for STE, the iteration or gradient equation is:

$${N}^{′} = N + {( {N}^{′} - N )}_{stop gradient} \qquad ( 2 )$$

where “stop gradient” refers to the fact that the “coder quantization” gradient computation is not used to generate the back propagation values. Specifically for STE, the N image data or pixel values from the original distortion loss function D(X, \hat{X}) before quantization and/or rounding are provided directly as back propagated gradient values. Thus, the gradients are computed based on the original function for gradient back propagation. The quantized values from the quantized and/or rounded function are used for forward propagation to generate the next iteration of images values of the output-decoder images N′ 510. The output from the decoder 512 and the images N′ computed by equation (2) above can be implemented in Pytorch® using the stop_gradient operation which can be implemented by using .detach( ) as expression N′=N+(N′−N).detach( ). This expression will automatically make use of the auto differentiation provided in PyTorch.

The implementation for distortion loss D(X, \hat{X}) may be performed in the machine learning and neural network operating application PyTorch® for example. By one example,

$$y = f ( x ) \qquad ( 3 )$$

If x is an integer, then:

$$y = f ( x - ( round ( x ) - x ) . detach ( ) ) \qquad ( 3 )$$

where “.detach( )” refers to the variable that does not participate in the computation graph. So (round(x)−x).detach( )) is similar to a variable sampled from somewhere else. Then automatic differentiation may be computed by PyTorch®.

Also, the distortion loss D(X, \hat{X}) in one example here may be a weighted sum of absolute error (L1), mean-square-error (MSE), and structural similarity index measure (SSIM) as follows:

$$D ( X , \hat{X} ) = α {L}_{L 1} ( X , \hat{X} ) + β {L}_{MSE} ( X , \hat{X} ) + γ {L}_{SSIM} ( X , \hat{X} ) \qquad ( 5 )$$

where α, β and γ are the weights for L1, MSE and SSIM loss, respectively, and this may be computed by the distortion loss unit 526. L_{SSIM}( ) may be computed by using known techniques.

As mentioned, the iterating 610 may include “factor auxiliary loss between input channels and output of pre-processor NN” 614. Here, the rate loss R from equation (1) can be at least partially regulated by factoring an auxiliary distortion loss D(X_{(channels)}, N) determined by auxiliary distortion loss unit 524, where the auxiliary distortion loss D(X_{(channels)}, N) is measured between the corresponding channels of X and N. One example equation to measure the auxiliary distortion loss D(X_{(channels)}, N) for an RG example (where B channel is dropped) is:

$$D ( {X}_{( channels )} , N ) = ) = \vert {X}_{RG} - {N}_{R G} \vert , \vert \cdot \vert \qquad ( 6 )$$

for an L1 distance.

Also, iterating 610 may include “perform discrete cosine transform (DCT) AC coefficient regulation” 616. Thus, in addition to, or instead of, factoring the auxiliary distortion, the rate loss R also can be regulated by, or factor, L2 regularization of AC-DCT coefficients by the AC coefficient regularization unit 522. This regularization results in a lower (i.e., smaller) entropy for the distribution of the AC part of the DCT coefficients. This operation also results in reducing the amount of data generated by using the STE.

In detail, this operation obtains the actual DCT coefficients from the encoder, and estimates the bitrate loss R, which may be an L2 regularization (e.g., the sum of squares of all AC coefficients of a frame). While the R estimation may be generalized to a gaussian distribution of the DCT coefficients, here a Laplacian distribution is used to approximate the AC coefficients. It should be noted that instead of DCT, other linear transforms in image processing may be used instead. Thus, in the present example, and for natural world images (e.g., captured photos that are non-computer generated or non-artificial), the AC coefficients can be approximated by a Laplacian distribution. For a Laplacian distribution, the differential entropy is

$$Ln ( 2 σ ) + 1 \qquad ( 7 )$$

where σ is the standard deviation of a Laplacian distribution. According to the equation, smaller σ results in smaller entropy. By one example then, a regularization term to make σ small may be:

$$\sum {S}^{2} \qquad ( 8 )$$

where S is the AC coefficients, which may be provided as a transform block of pixels, and in turn a block of the AC coefficients. This works because the direction of the derivative of equation (8) points to zero, and the magnitude of the derivative is 2|S|. Thus, this operation is similar to a penalization that scales down S toward zero. Because a Laplacian distribution is a symmetric distribution, this may be equivalent to making the standard deviation σ smaller for the DCT distribution.

It should be noted that this avoids weak correlation that can result from directly estimating the rate by a parameterized model, and minimizing the output from the model (estimated bitrate). In the presently disclosed method instead, bitrate is indirectly minimized by using regularization terms, such as from AC coefficient regularization and/or auxiliary distortion loss factors. The regularization terms were found in experiments to result in string correlation of the loss function, or R, to actual bitrates.

Thus, the final loss function L of equation (1) of the training system or arrangement 500 now may be expressed as:

$$L = D ( X , \hat{X} ) + {λ}_{IR} D ( {X}_{( channels )} , N ) + {λ}_{AC} \sum ( S ∈ AC ) {S}^{2} \qquad ( 9 )$$

where λ_{IR} and λ_{AC} are the loss weights for intermediate reconstruction and AC coefficients regularization, respectively. The iterations will form gradients for the loss weights λ_{IR} and λ_{AC} while also iterating the non-quantized gradients for weights α, β and γ for D(X, \hat{X}) (equation (5) above). The iterations may be performed until a convergence meets a minimum threshold determined by experimentation.

Experiments were performed with the training method of process 600 to show the effectiveness of the disclosed video coding methods and systems with PRPNN and POPNN and bit-depth reduction. The training and run-time operation of the system was performed on GPUs for operating the NNs and one or more CPUs for operating the encoder and decoder described herein. The machine learning and NN application PyTorch® was used for GPU operation and training, and FFMPEG was the codec used and operated by the CPU. Multi-processing was used for encoding and decoding a batch of data using FFMPEG. For each data sample, “−flags2+export_mvs” is used to extract motion vectors. Then, the motion vectors are converted to a N×H×W×2 motion flow in a PyTorch tensor that is normalized to [−1, 1]. The motion predicted frame is obtained using the grid_sample API in PyTorch® with the converted motion flow. U-Net was used for both pre- and post-processor. The model is trained on Vimeo-90K dataset.

Two experiments were performed. The first experiment reduced distortion by using less than all available color space channels, while the second experiment combined reducing channels with reducing the bit-depth the channels. The trained pre- and post-processing models were evaluated on Joint Collaborative Team on Video Coding (JCT-VC) sequences, PeopleOnStreet images, with H264 codec.

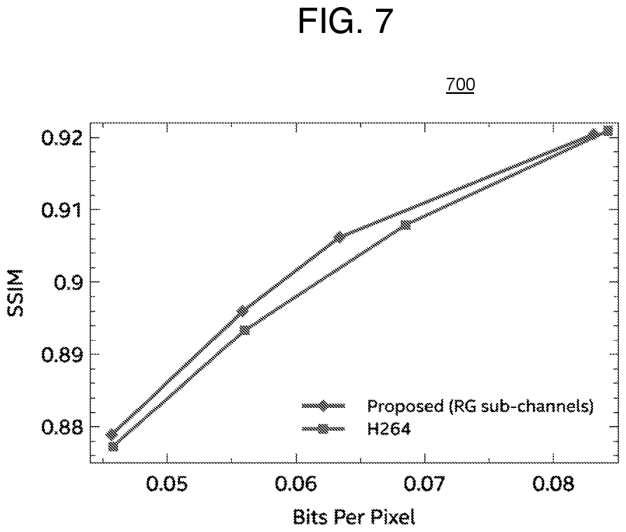

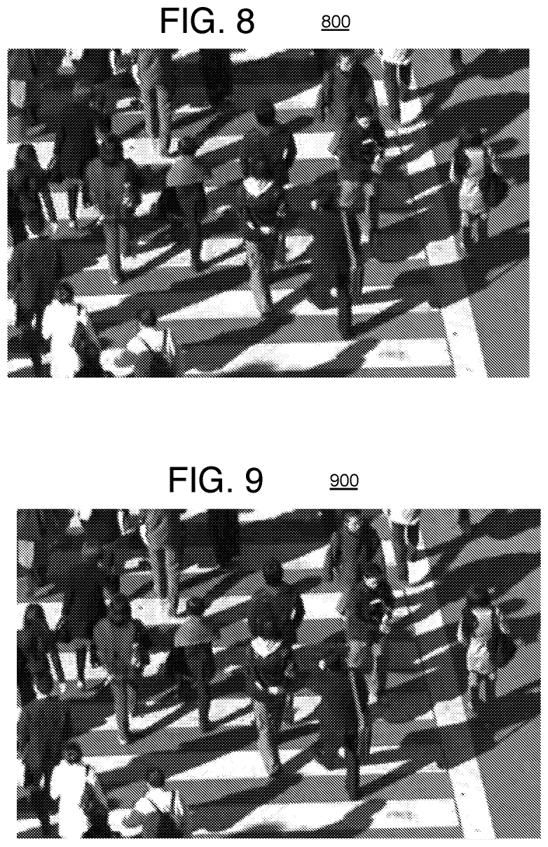

Referring to FIGS. 7-9 for the first experiment, graph 700 shows a resulting rate distortion (RD) curve indicating an improvement in SSIM compared to conventional H264 compression without neural networks. For this first experiment, an image (or image patch) 800 shows the conventional H.264 coding image, while image (or image patch) 900 shows the resulting reconstructed frame using the fewer channels as described herein. The reconstructed frame achieves better perceptual quality where the SSIM is higher, and the image content is sharper at a lower bitrate. Although a few slight color deviations exist for some regions, the image 900 has significantly reduced artifacts and much better-preserved details compared to the image 800 of the conventional coding. Specifically, the conventional image 800 is a video frame compressed by H264 alone without NNs, 6882 kb/s, and with a resulting SSIM of 0.8934, (Y: 0.8692, U: 0.9373, V: 0.9459), while the reconstructed image 900 according to the implementations herein, while using H264 with the PRPNN and POPNN, and at 6860 kb/s, resulted in SSIM of 0.8959, (Y: 0.8753, U: 0.9274, V: 0.9469).

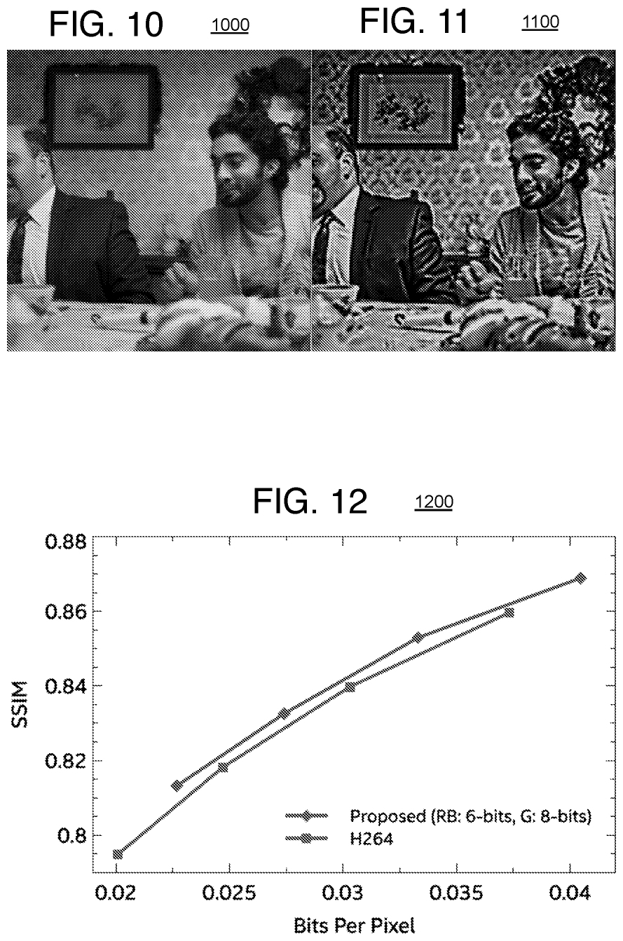

Referring to FIGS. 10-11, an original input image 1000 may be compared to an image 1100 with reduced per pixel bit-depth for different color channels compared to the original video frame 1000. Particularly, image 1100 may have a learned representation with R: 6-bits, G: 8-bits, B: 6-bits and intermediate reconstruction loss. From this perspective, the use of less than all color channels is merely a special case where one of the color channels uses zero bits. Extending this idea to use fewer but non-zero bits per pixel for compression improves the flexibility of the system and reduces the total bit load and bandwidth per frame as well as the floor for the possible lowest bitrate. Practically, the reduction of bit-depth may make the use of a real (or standard or un-modified) codec easier during training for color preservation because this approach can preserve more color information at least compared to the case in which one or two channels are dropped entirely.

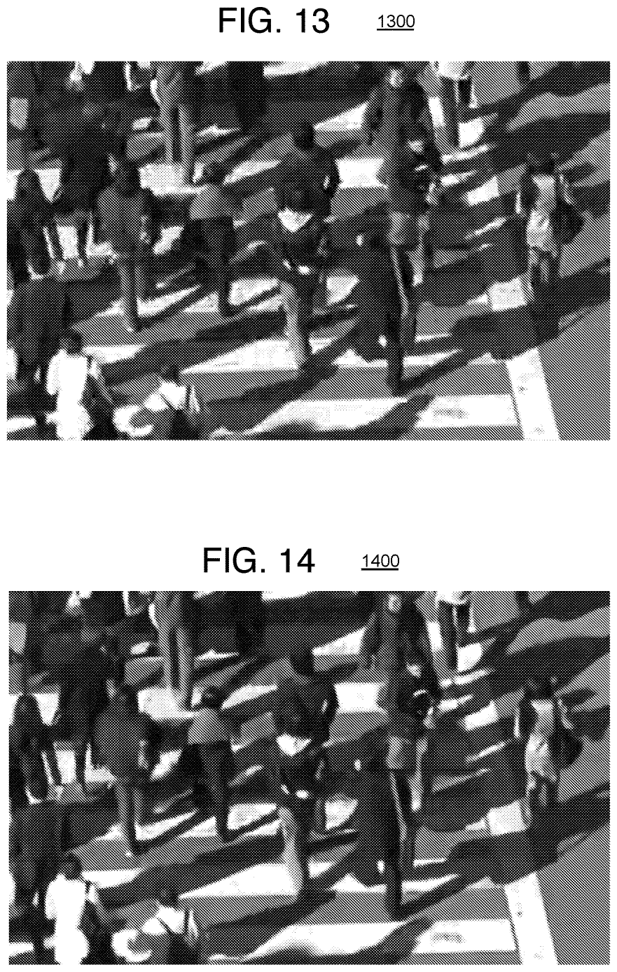

Thus, for the second experiment, R and B channels had bit-depths of 6-bits per pixel by limiting the pixel value in the range of 0 to 63, and the G channel had 8 bits to encode the video frames into a 20 bit color frame. The training settings are the same as above with the RG-channels of the first experiment. Here, the SSIM RD-curve is demonstrated in FIG. 12 on graph 1200, and example image patches are shown in FIGS. 13-14. Compared to RG-subchannels results (FIGS. 7-9) above, the present results with reduced bit-depths has a lower number of color deviations.

Particularly, rate distortion graph 1200 shows RD-curves and that the disclosed methods and training have better SSIM scores than the conventional H264 compression. Original image (or image patch) 1300 is a Video Frame compressed by H264, 4094 kb/s with a SSIM: 0.8488, (Y: 0.8063, U: 0.9282, V: 0.9399), while the image 1400 resulting from the methods herein with reduced bit-depths and a H264 coder at 4090 kb/s results in an SSIM: 0.8529, (Y: 0.8136, U: 0.9270, V: 0.9357).

While implementation of example processes 300, 400, and 600 may include the undertaking of all operations shown in the order illustrated, the present disclosure is not limited in this regard and, in various examples, implementation of any of the processes herein may include the undertaking of only a subset of the operations shown and/or in a different order than illustrated.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

As used in any implementation described herein, the term “logic unit” refers to any combination of firmware logic and/or hardware logic configured to provide the functionality described herein. The “hardware”, as used in any implementation described herein, may include, for example, singly or in any combination, hardwired circuitry, programmable circuitry, state machine circuitry, and/or firmware that stores instructions executed by programmable circuitry. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the coding systems discussed herein. One of ordinary skill in the art will appreciate that operations performed by hardware and/or firmware may alternatively be implemented via software, which may be embodied as a software package, code and/or instruction set or instructions, and also appreciate that logic unit may also utilize a portion of software to implement its functionality.

As used in any implementation described herein, the term “component” may refer to a module or to a logic unit, as these terms are described above. Accordingly, the term “component” may refer to any combination of software logic, firmware logic, and/or hardware logic configured to provide the functionality described herein. For example, one of ordinary skill in the art will appreciate that operations performed by hardware and/or firmware may alternatively be implemented via a software module, which may be embodied as a software package, code and/or instruction set, and also appreciate that a logic unit may also utilize a portion of software to implement its functionality.

The terms “circuit” or “circuitry,” as used in any implementation herein, may comprise or form, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor (“processor circuitry”) and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other implementations may be implemented as software executed by a programmable control device. In such cases, the terms “circuit” or “circuitry” are intended to include a combination of software and hardware such as a programmable control device or a processor capable of executing the software. As described herein, various implementations may be implemented using hardware elements, software elements, or any combination thereof that form the circuits, circuitry, processor circuitry. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Referring to FIG. 15, an example video coding system or device 1500 for providing video coding with pre-processing and post-processing neural networks may be arranged in accordance with at least some implementations of the present disclosure. In the illustrated implementation, system 1500 may include imaging device(s) 1501 such as one or more cameras, one or more central and/or graphics processing units or processors 1503, a display device 1505, one or more memory stores 1507, an antenna 1550 for wireless transmission, and processing unit(s) 1502 to perform the operations mentioned above. Processor(s) 1503, memory store 1507, and/or display device 1505 may be capable of communication with one another, via, for example, a bus, wires, or other access. In various implementations, display device 1505 may be integrated in system 1500 or implemented separately from system 1500.

As shown in FIG. 15, the processing unit(s) 1502 may have logic circuitry 1504 forming logic modules or units shown here with a pre-processing unit 1506 and a video encoder 1512. The logic circuitry 1504 alternatively, or additionally, may have a post-processing unit 1508 and a video decoder unit 1514. Also, the logic circuitry 1504 optionally may have a training unit 1510 or may be communicatively and remotely connected to such a training unit 1510.

The pre-processing unit 1506 may have an input PRP NN 1516 with an input bit-depth unit 1518 either as part of the PRP NN 1506 or communicating therewith. The video encoder unit 1512 may have encoder components such as partitioning units, transform, such as (DCT) and quantization units, decoder loop units, prediction units, including a motion estimation unit that uses motion vectors, and residual generating units, entropy unit, and so forth. Here, the video encoder unit 1512 also may include an other pre-processing unit 1524 and a color space convertor 1526 such as an RGB to YUV convertor when desired.

The video decoder unit 1514 may have decoder components such as an entropy decoder, inverse quantization and transform units, residual and image assemblers, filters, and decoder prediction units. Here, the video decoder unit 1514 also may have another post-processing unit 1528 and a color space convertor 1530 such as a YUV to RGB convertor when desired. The post-processing unit 1508 may have an output POP NN 1520 which may have a local or remote output bit-depth unit 1522.

The training unit 1510 may have a straight through estimation (STE) unit 1532, an AC coefficient regulation unit 1534, and any other units to perform the training as explained above. The training unit 1510 may be located locally on the logic circuitry 1504 and may be permanently disposed, or may be removable from the device 1500 after a training stage and for a run-time. Otherwise, the training unit 1510 may be remotely communicating with the neural networks and coders of device 1500. All of these units, logic, and/or modules of device 1500 perform the tasks as mentioned above and as the name of the unit implies.

As will be appreciated, the modules illustrated in FIG. 15 may include a variety of software and/or hardware modules, and/or modules that may be implemented via software or hardware or combinations thereof. For example, the modules may be implemented as software via processing units 1502 or the modules may be implemented via a dedicated hardware portion. Furthermore, the shown memory stores 1507 may be shared memory for processing units 1502, for example, storing any coder or neural network data, whether stored on any of the options mentioned above, or may be stored on a combination of these options, or may be stored elsewhere. Also, system 1500 may be implemented in a variety of ways. For example, system 1500 (excluding display device 1505) may be implemented as a single chip or device having a graphics processor unit (GPU), an image signal processor (ISP), a quad-core central processing unit, and/or a memory controller input/output (I/O) module. In other examples, system 1500 (again excluding display device 1505) may be implemented as a chipset or as a system on a chip (SoC).

Processor(s) 1503 may include any suitable implementation including, for example, microprocessor(s), multicore processors, application specific integrated circuits, chip(s), chipsets, programmable logic devices, graphics cards, integrated graphics, general purpose graphics processing unit(s), or the like. In addition, memory stores 1507 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory stores 1507 also may be implemented via cache memory.

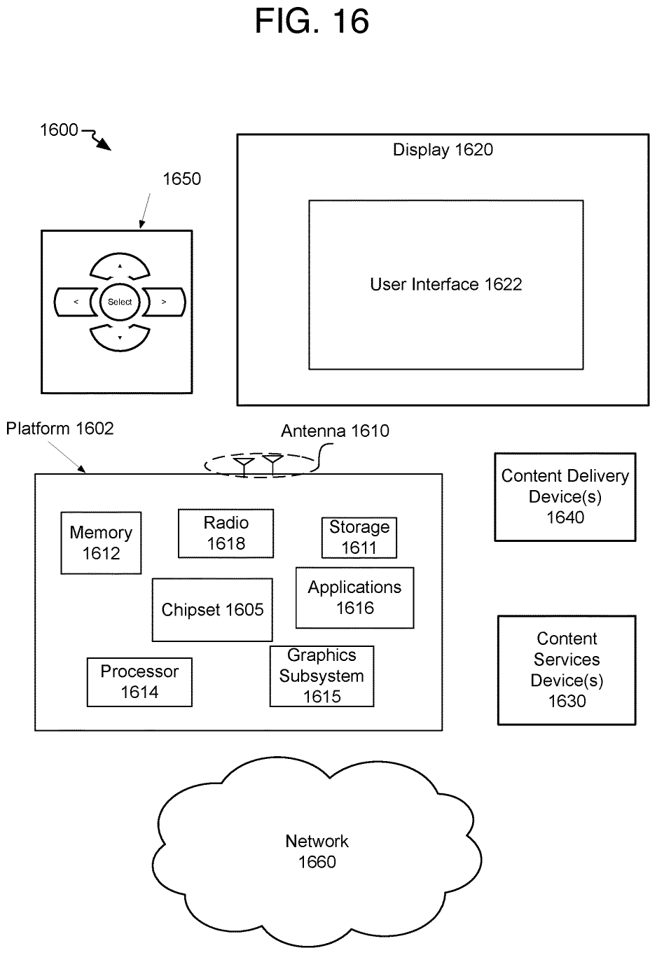

Referring to FIG. 16, an example system 1600 in accordance with the present disclosure and various implementations, may be a media system although system 1600 is not limited to this context. For example, system 1600 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In various implementations, system 1600 includes a platform 1602 communicatively coupled to a display 1620. Platform 1602 may receive content from a content device such as content services device(s) 1630 or content delivery device(s) 1640 or other similar content sources. A navigation controller 1650 including one or more navigation features may be used to interact with, for example, platform 1602 and/or display 1620. Each of these components is described in greater detail below.

In various implementations, platform 1602 may include any combination of a chipset 1605, antenna 1610, memory 1612, storage 1611, graphics subsystem 1615, applications 1616 and/or radio 1618 as well as antenna(s) 1610. Chipset 1605 may provide intercommunication among processor 1614, memory 1612, storage 1611, graphics subsystem 1615, applications 1616 and/or radio 1618. For example, chipset 1605 may include a storage adapter (not depicted) capable of providing intercommunication with storage 1611.

Processor 1614 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 1614 may be dual-core processor(s), dual-core mobile processor(s), and so forth.

Memory 1612 may be implemented as a volatile memory device such as, but not limited to, a Random Access Memory (RAM), Dynamic Random Access Memory (DRAM), or Static RAM (SRAM).

Storage 1611 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1611 may include technology to increase the storage performance enhanced protection for valuable digital media when multiple hard drives are included, for example.

Graphics subsystem 1615 may perform processing of images such as still or video for display. Graphics subsystem 1615 may be a graphics processing unit (GPU) or a visual processing unit (VPU), for example. An analog or digital interface may be used to communicatively couple graphics subsystem 1615 and display 1620. For example, the interface may be any of a High-Definition Multimedia Interface, Display Port, wireless HDMI, and/or wireless HD compliant techniques. Graphics subsystem 1615 may be integrated into processor 1614 or chipset 1605. In some implementations, graphics subsystem 1615 may be a stand-alone card communicatively coupled to chipset 1605.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In other implementations, the functions may be implemented in a consumer electronics device.

Radio 1618 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1618 may operate in accordance with one or more applicable standards in any version.

In various implementations, display 1620 may include any television type monitor or display. Display 1620 may include, for example, a computer display screen, touch screen display, video monitor, television-like device, and/or a television. Display 1620 may be digital and/or analog. In various implementations, display 1620 may be a holographic display. Also, display 1620 may be a transparent surface that may receive a visual projection. Such projections may convey various forms of information, images, and/or objects. For example, such projections may be a visual overlay for a mobile augmented reality (MAR) application. Under the control of one or more software applications 1616, platform 1602 may display user interface 1622 on display 1620.

In various implementations, content services device(s) 1630 may be hosted by any national, international and/or independent service and thus accessible to platform 1602 via the Internet, for example. Content services device(s) 1630 may be coupled to platform 1602 and/or to display 1620. Platform 1602 and/or content services device(s) 1630 may be coupled to a network 1660 to communicate (e.g., send and/or receive) media information to and from network 1660. Content delivery device(s) 1640 also may be coupled to platform 1602 and/or to display 1620.

In various implementations, content services device(s) 1630 may include a cable television box, personal computer, network, telephone, Internet enabled devices or appliance capable of delivering digital information and/or content, and any other similar device capable of unidirectionally or bidirectionally communicating content between content providers and platform 1602 and/display 1620, via network 1660 or directly. It will be appreciated that the content may be communicated unidirectionally and/or bidirectionally to and from any one of the components in system 1600 and a content provider via network 1660. Examples of content may include any media information including, for example, video, music, medical and gaming information, and so forth.

Content services device(s) 1630 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1602 may receive control signals from navigation controller 1650 having one or more navigation features. The navigation features of controller 1650 may be used to interact with user interface 1622, for example. In implementations, navigation controller 1650 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 1650 may be replicated on a display (e.g., display 1620) by movements of a pointer, cursor, focus ring, or other visual indicators displayed on the display. For example, under the control of software applications 1616, the navigation features located on navigation controller 1650 may be mapped to virtual navigation features displayed on user interface 1622, for example. In implementations, controller 1650 may not be a separate component but may be integrated into platform 1602 and/or display 1620. The present disclosure, however, is not limited to the elements or in the context shown or described herein.

In various implementations, drivers (not shown) may include technology to enable users to instantly turn on and off platform 1602 like a television with the touch of a button after initial boot-up, when enabled, for example. Program logic may allow platform 1602 to stream content to media adaptors or other content services device(s) 1630 or content delivery device(s) 1640 even when the platform is turned “off.” In addition, chipset 1605 may include hardware and/or software support for 7.1 surround sound audio and/or high definition (7.1) surround sound audio, for example. Drivers may include a graphics driver for integrated graphics platforms. In implementations, the graphics driver may comprise a peripheral component interconnect (PCI) Express graphics card.

In various implementations, any one or more of the components shown in system 1600 may be integrated. For example, platform 1602 and content services device(s) 1630 may be integrated, or platform 1602 and content delivery device(s) 1640 may be integrated, or platform 1602, content services device(s) 1630, and content delivery device(s) 1640 may be integrated, for example. In various implementations, platform 1602 and display 1620 may be an integrated unit. Display 1620 and content service device(s) 1630 may be integrated, or display 1620 and content delivery device(s) 1640 may be integrated, for example. These examples are not meant to limit the present disclosure.

In various implementations, system 1600 may be implemented as a wireless system, a wired system, or a combination of both. When implemented as a wireless system, system 1600 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1600 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1602 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The implementations, however, are not limited to the elements or in the context shown or described in FIG. 16.

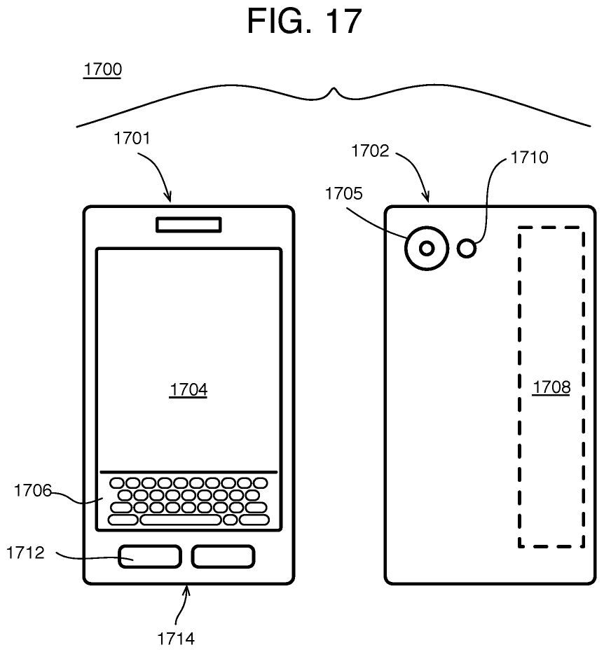

Referring to FIG. 17, a small form factor device 1700 is one example of the varying physical styles or form factors in which systems 1500 or 1600 may be embodied. By this approach, device 1700 may be implemented as a mobile computing device having wireless capabilities. A mobile computing device may refer to any device having a processing system and a mobile power source or supply, such as one or more batteries, for example.

As described above, examples of a mobile computing device may include a digital still camera, digital video camera, mobile devices with camera or video functions such as imaging phones, webcam, personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various implementations, for example, a mobile computing device may be implemented as a smart phone capable of executing computer applications, as well as voice communications and/or data communications. Although some implementations may be described with a mobile computing device implemented as a smart phone by way of example, it may be appreciated that other implementations may be implemented using other wireless mobile computing devices as well. The implementations are not limited in this context.

As shown in FIG. 17, device 1700 may include a housing with a front 1701 and a back 1702. Device 1700 includes a display 1704, an input/output (I/O) device 1706, and an integrated antenna 1708. Device 1700 also may include navigation features 1712. I/O device 1706 may include any suitable I/O device for entering information into a mobile computing device. Examples for I/O device 1706 may include an alphanumeric keyboard, a numeric keypad, a touch pad, input keys, buttons, switches, microphones, speakers, voice recognition device and software, and so forth. Information also may be entered into device 1700 by way of microphone 1714, or may be digitized by a voice recognition device. As shown, device 1700 may include a camera 1705 (e.g., including at least one lens, aperture, and imaging sensor) and a flash 1710 integrated into back 1702 (or elsewhere) of device 1700. The implementations are not limited in this context.

Various forms of the devices and processes described herein may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects described above may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to additional implementations.

In example 1, a method of video coding comprises inputting initial image data values of at least one initial bit-depth and of frames of a video sequence into a pre-processing neural network (PRPNN) having multiple input channels; generating, by the PRPNN, encoder-input image data comprising reducing the initial bit-depth from the initial image data values of at least one of the input channels; and encoding a version of the encoder-input image data.

In example 2, the subject matter of example 1, wherein the method comprises decoding compressed encoder-input image data comprising generating a version of decoder-output image data; and inputting the version of decoder-output image data into a post-processing neural network (POPNN) arranged to increase a bit-depth of image data values of at least one channel of the decoder-output image data associated with the at least one input channel.

In example 3, the subject matter of example 1 or 2 wherein the initial bit-depth is 8 bits or greater, and the method comprises reducing the initial bit-depth to be below 8-bits at the output of the PRPNN.

In example 4, the subject matter of any one of examples 1-3 wherein the initial bit-depth is reduced to 4 to 6 bits.

In example 5, the subject matter of any one of examples 1-4 wherein the PRPNN outputs three channels and all three channels have image data with reduced bit-depths less than the initial bit-depth.

In example 6, the subject matter of any one of examples 1-4 wherein the PRPNN outputs three channels and two of the three channels have image data with reduced bit-depths less than the initial bit-depth.

In example 7, the subject matter of any one of examples 1-4 wherein the PRPNN outputs three channels and only one of the three channels has image data with reduced bit-depths less than the initial bit-depth.

In example 8, the subject matter of any one of examples 1-4 wherein the initial image data is provided in an RGB color space, and three output channels of the PRPNN each corresponds to one of the color channels of the color space, and wherein one of RG, GB, and RB channels output at the output of PRPNN has reduced bit-depths less than the initial bit depth.

In example 9, the subject matter of any one of examples 1-8 wherein the method comprises using an encoder in a state sufficient to be used during a run-time to train the PRPNN and POPNN rather than using an image codec proxy.

In example 10, a computer-implemented system comprises memory to store initial image data values of at least one initial bit-depth and of at least one frame of a video sequence; and processor circuitry forming at least one processor communicatively coupled to the memory, and the at least one processor being arranged to operate by: inputting initial image data values of at least one initial bit-depth and of frames of a video sequence into a pre-processing neural network (PRPNN) having multiple input channels; generating, by the PRPNN, encoder-input image data comprising reducing the initial bit-depth from the initial image data values of at least one of the input channels; and encoding a version of the encoder-input image data to be subsequently decoded to generate a version of decoder-output image data arranged to be input into a post-processing neural network (POPNN) arranged to increase a bit-depth of image data values associated with the at least one input channel.

In example 11, the subject matter of example 12 wherein the multiple input channels comprises three channels to correspond to color space channels, and wherein the at least one processor is arranged to operate by inputting initial image data for less than three channels and entering zeros rather than initial image data into each of the three channels that is not being used.

In example 12, the subject matter of examples 10 or 11 wherein the encoding comprises encoding at least one channel of encoder-input image data having image data values with a bit-depth of six or less bits.

In example 13, the subject matter of any one of examples 10 to 12 wherein the encoding comprises encoding at least one channel of encoder-input image data having image data values with a bit-depth smaller than the bit-depth of the initial image and reduced by dropping non-consecutive bit locations in individual encoder-input image data values.

In example 14, the subject matter of any one of examples 10 to 12 wherein the at least one processor is arranged to operate by adjusting bit-depths of data values associated with a layer of the PRPNN or POPNN and comprising clamping the data values to a floating point range indicating a target number of bits that is respectively a reduced or increased bit-depth.

In example 15, the subject matter of any one of examples 10 to 14 wherein a bit location within individual image values of the encoder-input image data and to be dropped to reduce a bit-depth of the individual image values is different from output channel to output channel of the PRPNN.

In example 16, the subject matter of any one of examples 10 to 15 wherein the PRPNN has three output channels corresponding to three channels of a color space, and the bit depth is different on each output channel.

In example 17, the subject matter of any one of examples 10 to 16 wherein the bit reduction is applied to the output of the last layer of the PRPNN.

In example 18, at least one non-transitory article having at least one computer-readable medium having stored thereon instructions that when executed cause a computing device to operate by: inputting initial image data values of an initial bit-depth and of frames of a video sequence into a pre-processing neural network (PRPNN) having multiple input channels; generating, by the PRPNN, encoder-input image data comprising reducing the initial bit-depth of the initial image data values of at least one of the input channels; and encoding and subsequently decoding a version of the encoder-input image data to generate decoder-output image data, and inputting a version of the decoder-output image data into a post-processing neural network (POPNN) arranged to increase a bit-depth of image data values associated with the at least one channel.

In example 19, the subject matter of example 18 wherein bit locations to be dropped within initial image data to reduce a bit-depth of the encoder-input image data relative to the initial image data are predetermined and are not limited to specific bit locations within the initial image data due to the encoder.

In example 20, the subject matter of example 18 or 19 wherein one or consecutive multiple least significant bit (LSB) locations are dropped to reduce bit-depth of the encoder-input image data relative to the initial image data.

In example 21, the subject matter of example 18 or 19 one or more middle bit locations of the initial image data are dropped to reduce bit-depth of the encoder-input image data relative to the initial image data.

In example 22, the subject matter of any one of examples 18 to 21 wherein bit-depth reduction is performed before initial image data is input to input channels of the PRPNN.

In example 23, the subject matter of any one of examples 18 to 22 wherein a bit-depth increase is performed before the decoder-output image data is input to input channels of the POPNN.

In example 24, the subject matter of any one of examples 18-23 wherein the instructions are caused to operate by training the PRPNN and POPNN using coders and codec arranged to operate during a run-time rather than using an image codec proxy, and comprising using straight through estimating to generate gradients of back propagation.

In example 25, the subject matter of any one of examples 18-24 wherein the instructions are caused to operate by training the PRPNN and POPNN comprising performing discrete cosine transform (DCT) AC coefficient regulation to modify the gradients.

In example 26, the subject matter of any one of examples 18-25 wherein the instructions are caused to operate by training the PRPNN to have the PRPNN output a channel with zero value image data associated with an input channel of zero values.

In example 27, the subject matter of any one of examples 18-26 wherein quantization or rounding or both from the input-encoder image data being encoded are provided directly as back propagated gradient values, and wherein quantized or rounded or both values from the encoding of the input-encoder image data are used for forward propagation to generate a next iteration.

In example 28, the subject matter of any one of examples 18-27 wherein the instructions are caused to operate by inputting at least one channel of zero image data values into the POPNN.

In one example, a device, apparatus, or system includes means to perform a method according to any one of the above implementations.

In another example, at least one machine readable medium includes a plurality of instructions that in response to being executed on a computing device, cause the computing device to perform a method according to any one of the above implementations.

It will be recognized that the implementations are not limited to the implementations so described, but can be practiced with modification and alteration without departing from the scope of the appended claims. For example, the above implementations may include specific combination of features. However, the above implementations are not limited in this regard, and, in various implementations, the above implementations may include the undertaking only a subset of such features, undertaking a different order of such features, undertaking a different combination of such features, and/or undertaking additional features than those features explicitly listed. The scope of the implementations should, therefore, be determined with reference to the appended claims, along with the full scope of equivalents to which such claims are entitled.

1. A method of video coding, comprising:
inputting initial image data values of at least one initial bit-depth and of frames of a video sequence into a pre-processing neural network (PRPNN) having multiple input channels;
generating, by the PRPNN, encoder-input image data comprising reducing the initial bit-depth from the initial image data values of at least one of the input channels; and
encoding a version of the encoder-input image data.

2. The method of claim 1, comprising:
decoding compressed encoder-input image data comprising generating a version of decoder-output image data; and inputting the version of decoder-output image data into a post-processing neural network (POPNN) arranged to increase a bit-depth of image data values of at least one channel of the decoder-output image data associated with the at least one input channel.

3. The method of claim 1, wherein the initial bit-depth is 8 bits or greater, and the method comprising reducing the initial bit-depth to be below 8-bits at an output of the PRPNN.

4. The method of claim 1, wherein the initial bit-depth is reduced to 4 to 6 bits.

5. The method of claim 1, wherein the PRPNN outputs three channels and all three channels have image data with reduced bit-depths less than the initial bit-depth.

6. The method of claim 1, wherein the PRPNN outputs three channels and two of the three channels have image data with reduced bit-depths less than the initial bit-depth.

7. The method of claim 1, wherein the PRPNN outputs three channels and only one of the three channels has image data with reduced bit-depths less than the initial bit-depth.

8. The method of claim 1, wherein the initial image data values are provided in an RGB color space, and three output channels of the PRPNN each corresponds to one of color channels of the color space, and wherein one of RG, GB, and RB channels output at the output of PRPNN has reduced bit-depths less than the initial bit-depth.

9. The method of claim 1, comprising using an encoder in a state sufficient to be used during a run-time to train the PRPNN and POPNN rather than using an image codec proxy.

10. A system comprising:
memory to store initial image data values of at least one initial bit-depth and of at least one frame of a video sequence; and
processor circuitry forming at least one processor communicatively coupled to the memory, and the at least one processor being arranged to operate by:
inputting initial image data values of at least one initial bit-depth and of frames of a video sequence into a pre-processing neural network (PRPNN) having multiple input channels;
generating, by the PRPNN, encoder-input image data comprising reducing the initial bit-depth from the initial image data values of at least one of the input channels; and
encoding a version of the encoder-input image data to be subsequently decoded to generate a version of decoder-output image data arranged to be input into a post-processing neural network (POPNN) arranged to increase a bit-depth of image data values associated with the at least one input channel.

11. The system of claim 10, wherein:
the multiple input channels comprises three channels to correspond to color space channels, and wherein the at least one processor is arranged to operate by inputting initial image data for less than three channels and entering zeros rather than initial image data into each of the three channels that is not being used.

12. The system of claim 10, wherein the encoding comprises encoding at least one channel of encoder-input image data having image data values with a bit-depth of six or less bits.

13. The system of claim 10, wherein the encoding comprises encoding at least one channel of encoder-input image data having image data values with a bit-depth smaller than the initial bit-depth of the initial image and reduced by dropping non-consecutive bit locations in individual encoder-input image data values.

14. The system of claim 10, wherein the at least one processor is arranged to operate by adjusting bit-depths of data values associated with a layer of the PRPNN or POPNN and comprising clamping the data values to a floating point range indicating a target number of bits that is respectively a reduced or increased bit-depth.

15. The system of claim 10, wherein a bit location within individual image values of the encoder-input image data and to be dropped to reduce a bit-depth of the individual image values is different from output channel to output channel of the PRPNN.

16. The system of claim 10, wherein the PRPNN has three output channels corresponding to three channels of a color space, and a bit-depth of each output channel is different.

17. The system of claim 10, wherein the reducing of the initial bit-depth is applied to an output of a last layer of the PRPNN.

18. At least one non-transitory computer-readable medium having stored thereon instructions that when executed cause a computing device to operate by:
inputting initial image data values of an initial bit-depth and of frames of a video sequence into a pre-processing neural network (PRPNN) having multiple input channels;
generating, by the PRPNN, encoder-input image data comprising reducing the initial bit-depth of the initial image data values of at least one of the input channels; and
encoding and subsequently decoding a version of the encoder-input image data to generate decoder-output image data, and inputting a version of the decoder-output image data into a post-processing neural network (POPNN) arranged to increase a bit-depth of image data values associated with the at least one of the input channels.

19. The at least one non-transitory computer-readable medium of claim 18, wherein bit locations to be dropped within initial image data to reduce a bit-depth of the encoder-input image data relative to the initial image data are predetermined and are not limited to specific bit locations within the initial image data due to the encoder.

20. The at least one non-transitory computer-readable medium of claim 18, wherein one or consecutive multiple least significant bit (LSB) locations are dropped to reduce a bit-depth of the encoder-input image data relative to the initial image data.

21. (canceled)

22. (canceled)

23. (canceled)

24. (canceled)

25. (canceled)
